(19) United States
(12) Patent Application Publication
(10) Pub. No.: US 2012/0123706 A1
(43) Pub. Date: May 17, 2012

(54) SYSTEMS AND METHODS FOR TANK LEVEL METERING

(76) Inventors: David Lansdell Armitage, Golden, CO (US); Gregory Froim Kushnir, Denver, CO (US); Mark Alvin Mason, Thornton, CO (US)

(21) Appl. No.: 13/270,800

(22) Filed: Oct. 11, 2011

Related U.S. Application Data
(60) Provisional application No. 61/391,697, filed on Oct. 11, 2010.

(51) Int. Cl. G01F 23/284; G06F 19/00

(52) U.S. Cl. 702/55; 73/290 V

(57) ABSTRACT

The present invention relates to determining the level of liquid in a tank. Electronic sensing devices are used to determine the liquid level in the tank. In some embodiments, a laser pulse is transmitted to a reflector floating on the surface of the liquid and the laser pulse is reflected back allowing for the determination of the depth of the liquid based on the return time of the laser pulse and the known distance to the bottom of the tank.

### RELATED APPLICATIONS

This non-provisional patent application is related to and claims priority to U.S. Provisional Patent Application No. 61/391,697, entitled “Systems and Methods for Tank Level Metering,” filed on Oct. 11, 2010, which is hereby incorporated by reference in its entirety.

### TECHNICAL FIELD

Aspects of the disclosure are related to the field of electronic sensing devices, and in particular, tank level metering systems.

### BACKGROUND

Liquids are stored in containment vessels such as tanks for use in a wide variety of commercial, residential, and agriculture applications. Liquids used in these applications include water, fuels, industrial chemicals, manufacturing ingredients, liquid fertilizers, as well as many others. Because the liquids stored in these tanks are used and replenished at varying rates, it is often necessary to assess the liquid level in the tank to determine the quantity of liquid remaining in the tank.

There are many different ways in which to determine liquid level in a tank. Some of the most basic ways to determine the liquid level in a tank include visual inspection or physically sticking a measuring a device into the tank. Other ways of determining liquid level in a tank include ultrasonic transmitters and mechanical floats.

### OVERVIEW

A system and method for metering a liquid level in a tank are provided. The method includes transmitting a laser pulse from a transmitter located a known distance from the bottom of the tank, reflecting the laser pulse from a reflector floating on the surface of a liquid, receiving the reflected laser pulse, determining a return time of the reflected pulse, and determining the depth of the liquid based on the return time and the known distance.

The system includes a transmitter located a known distance from the bottom of a tank configured to transmit and receive a laser pulse, a reflector floating on the surface of a liquid configured to reflect the laser pulse, and a processor configured to determine a return time of the reflected laser pulse and to determine the depth of the liquid based on the return time and the known distance.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system for tank level metering.

FIG. 2 illustrates a system for tank level metering.

FIG. 3 illustrates a method of operating a system for tank level metering.

### DETAILED DESCRIPTION

The following description and associated drawings depict specific embodiments of the invention to teach those skilled in the art how to make and use the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments and variations of the invention. As a result, the invention is not limited to the specific embodiments described below, but only by the claims and their equivalents.

Liquids are stored in containment vessels such as tanks for use in a wide variety of commercial, residential, and agriculture applications. Liquids used in these applications include water, fuels, industrial chemicals, manufacturing ingredients, liquid fertilizers, as well as many others. Because the liquids stored in these tanks are used and replenished at varying rates, it is often necessary to assess the liquid level in the tank to determine the quantity of liquid remaining in the tank. There are existing methods of making tank level measurements but each of these methods has unresolved problems or will not work in some applications.

A basic method of determining liquid level in a tank is to visually look inside the tank or stick a measuring device of some type into the liquid to measure the depth of the liquid remaining in the tank. These methods have several disadvantages. First, the person performing the measurement must be physically present at the tank. Second, the person must access the interior of the tank and possibly stick an object into the tank. In addition to the inconvenience, there may be issues if the liquid is dangerous, gives off noxious fumes, must be kept in a controlled environment, or is subject to contamination.

Some tanks are remotely located. Therefore, a tank level measurement method which requires a person to be physically present at the tank is both inconvenient and costly. These types of remote locations may have minimal power available and a tank metering system may be required to run for extended periods on battery power or from relatively small amounts of power generated by solar cells. In addition, these tanks may be located in challenging environments. The components of a metering system must be stable and reliable even though exposed to harsh environments and extreme weather conditions. These conditions may be such that they vary the operating conditions inside the tank as well.

Even if the tanks are not remote, they may be so numerous or reside in a controlled environment such that individual visits to each tank are not practical. Complex industrial processes which involve many liquids in many tanks may require readily available, frequently updated tank level information in electronic form in order for the industrial process control systems to operate effectively.

Some of the issues discussed above are resolved by including an optical port on the tank which allows visual detection of the liquid level inside the tank from the outside of the tank without opening or breaching the tank. This approach may not be effective if the liquid is not easy to see or the optical port becomes clouded or contaminated. In addition, this approach still requires the person making the measurement to be physically present at the tank to make the measurement. Because many tanks are located in distant or remote locations where access is difficult, it is desirable to meter tank levels in a remote manner. Even where tanks are readily accessible, the number of tanks may be so large or the levels may change so quickly that it is necessary to monitor many tanks remotely for efficiency purposes.

An ultrasonic transmitter may be used inside the tank to attempt to determine the surface level of the liquid. This method may not be effective if gaseous conditions exist above the liquid surface and the measurement may be affected by temperature variations. In addition, calibration of these devices can be non-linear and problematic depending upon the conditions inside the tank.

Mechanical floats of various types are also used. These mechanical methods usually utilize a device which floats on the surface of the liquid and uses one of a variety of means to convert the mechanical movement or position of the float into an electrical signal. The mechanical components, moving components, and the point at which the mechanical movement is converted to an electrical signal are all subject to the chemical and environmental conditions within the tank. Because these mechanical and electrical components are either submersed in the liquid or reside near the surface of the liquid, they are often prone to corrosion, contamination, and fouling thereby making the mechanical float approach unreliable.

Tank level metering could also be performed using standing wave radar methods. A standing wave is a wave which appears to remain in a stationary position and can occur when a wave is transmitted toward an object or surface and reflected from that object or surface. The transmitted and reflected waves combine to form a standing wave. The characteristics of the standing wave can be used to determine the distance from the reflecting object or surface. While standing wave radar may be used inside a tank to measure the surface level of the liquid, the electronic components required are generally expensive, use a relatively large amount of power, and can be sensitive to varying conditions.

The range of liquids used has many different characteristics and in each case contact with or exposure to the liquid presents unique challenges including toxicity, gaseous fumes, temperature control, and contamination, as well as others. Therefore, it is desirable to measure tank levels in an inexpensive, automated fashion which is minimally affected by ambient and gaseous conditions, requires minimal calibration, uses minimal power, and is resistant to corrosion, fouling, and contamination.

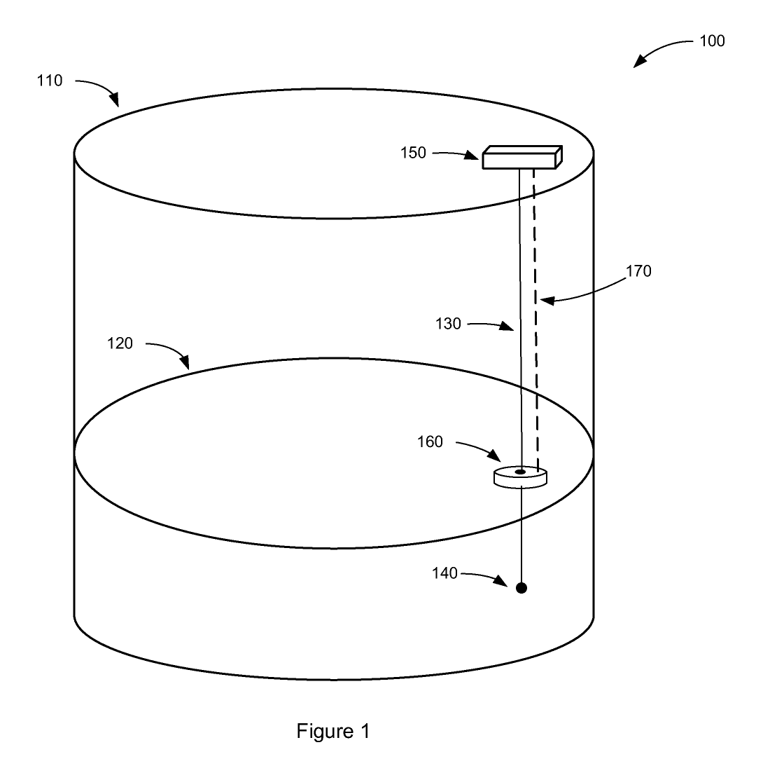

FIG. 1 illustrates system 100 for tank level metering. Tank 110 is partially filled with liquid 120. The purpose of the system is the measure the surface level of liquid 120 in order to determine the amount of liquid 120 which is remaining in tank 110. Guide line 130 is attached at or near the top of the interior of tank 110. The other end of guide line 130 is attached at or near the bottom of tank 110 by anchor 140. Anchor 140 may be either a device which physically attaches guide line 130 to the bottom of tank 110 or may be a weight which hangs from guide line 130 and holds it in an essentially vertical position.

Reflector 160 is made of a material which causes it to float on the surface of liquid 120. It has at least one hole through which guide line 130 passes. As the level of liquid 120 changes in the tank, reflector 160 floats at the surface of liquid 120 while following a vertical line defined by guide line 130. Reflector 160 also has an upward facing surface coated with a material designed to reflect laser light.

Control unit 150 is positioned at or near the top of the tank a known distance from the bottom of the tank. Control unit 150 comprises a laser transmitter, laser receiver, and a processor capable of performing timing measurements. Control unit 150 causes the laser to transmit a laser beam toward reflector 160. The beam travels along path 170, is reflected by reflector 160, travels back towards control unit 150 along essentially the same path, and is received by control unit 150. The processor in control unit 150 determines the distance to reflector 160 based on the time taken for the laser beam to return. Based on the known distance to the bottom of the tank, control unit 150 then determines the level of liquid 120 in tank 110.

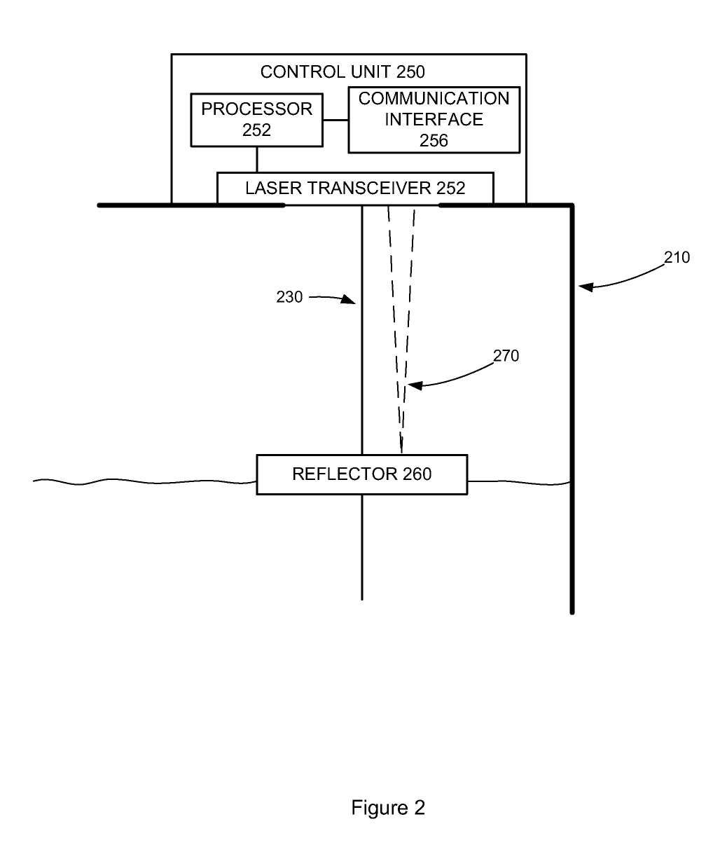

FIG. 2 illustrates a system for tank level metering. Only a portion of tank 210 is shown in FIG. 2. The system comprises control unit 250, guide line 230, and reflector 260. Control unit 250 further comprises processor 252, laser transceiver 254, and communication interface 256.

Control unit 250 is located at or near the top of tank 210 a known distance from the bottom of tank 210. Guide line 230 is attached at or near the top of tank 210 to control unit 250 or to tank 210. The other end of guide line 230 is attached or held in place at or near the bottom of tank 210.

Reflector 260 is made of a material which causes it to float on the surface of liquids. It has at least one hole through which guide line 230 passes. As the level of the liquid in tank 210 changes, reflector 260 floats at the liquid surface while following a line defined by guide line 230. Reflector 260 also has an upward facing surface coated with a material designed to reflect laser light.

Control unit 250 controls the measuring process. Control unit 250 may periodically perform these measurements based on a predefined schedule or may only make these measurements when commanded to do so. Such a command could be received at processor 252 though various means of communication received at communication interface 256.

Processor 252 causes laser transceiver 254 to transmit a laser pulse in order to determine the distance to reflector 260. The measurement operates on the time of flight principle wherein sending the laser pulse in a narrow beam towards reflector 260 and measuring the time taken by the pulse to be reflected and returned. The beam travels along path 270 and is reflected by reflector 260. The reflected beam travels back towards control unit 250 along essentially the same path. However, that path may vary slightly due to spreading or due to the exact positioning of reflector 260.

While the simplest case of transmitting a single laser pulse and waiting for the return is described, there are many other laser range finding techniques which are known in the art. These methods involve sending multiple pulses, pulse coding, frequency phase shifting, modulation, and interferometry as well as other means of discrimination which improve the accuracy, reliability, and speed of these measurements. The present invention is not limited to the method wherein a single pulse is transmitted and encompasses the other laser range finding techniques known in the art.

When the reflected pulse is received by laser transceiver 254, processor 252 determines the distance to reflector 260 based on the time taken for the laser pulse to travel to reflector 260 and return. Based on the known distance between control unit 250 and the bottom of tank 210, processor 252 determines the level of the liquid in tank 210. Processor 252 may store this measurement data for later use or may immediately transfer this measurement data over communication interface 256.

Communication interface 256 may communicate the measurement data to a receiving device over a wired connection in compliance with one of many standards. Communication interface 256 may also contain a wireless transceiver which transmits the measurement over a wireless connection. This wireless transmission may conform to one of many standards including Bluetooth, cellular communication standards, or any other wireless communication standard. The data may be transferred in the form of a text message, email, audio file, graphical chart, or other format.

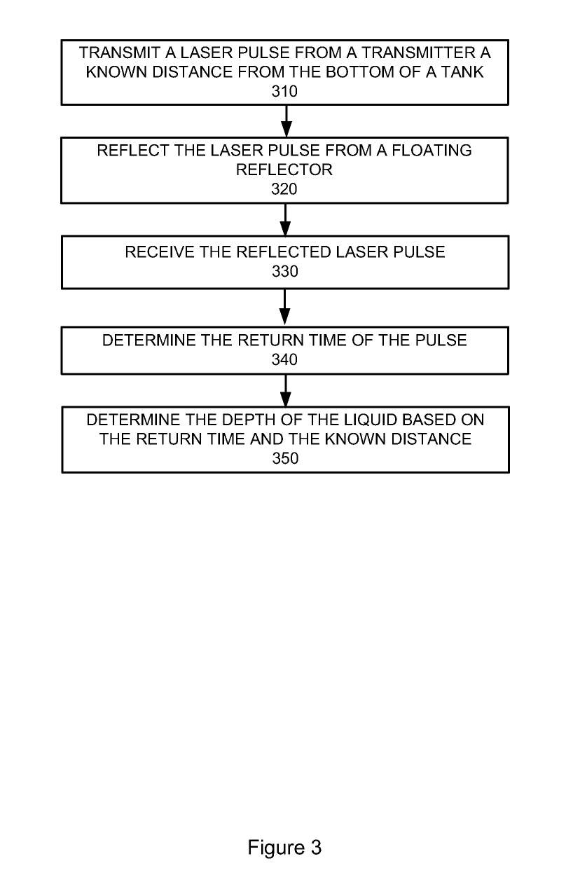

FIG. 3 illustrates a method of operating a system for tank level metering. The first step is to transmit a laser pulse from a transmitter located a known distance from the bottom of the tank (step 310). The laser pulse is reflected from a reflector floating on the surface of a liquid (step 320) and the reflected pulse is received (step 330). The next step is to determine a return time of the reflected pulse (step 340). Then, the depth of the liquid is determined based on the return time and the known distance (step 350).

The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a tank level metering system, comprising:
transmitting a laser pulse from a transmitter located a known distance from the bottom of the tank;
reflecting the laser pulse from a reflector floating on the surface of a liquid;
receiving the reflected laser pulse;
determining a return time of the reflected laser pulse; and
determining the depth of the liquid based on the return time and the known distance.

2. The method of claim 1, wherein the reflector is attached to a guide line.

3. The method of claim 1, comprising reporting the depth of the liquid through a communication interface.

4. A tank level metering system, comprising:
a transmitter located a known distance from the bottom of a tank, configured to transmit and receive a laser pulse;
a reflector floating on the surface of a liquid, configured to reflect the laser pulse; and
a processor, configured to determine a return time of the reflected laser pulse and to determine the depth of the liquid based on the return time and the known distance.

5. The system of claim 4, comprising a guide line configured to allow the reflector to follow a line defined by the guide line.

6. The system of claim 4, comprising a communication interface configured to report the depth of the liquid.
